(19) United States
(12) Patent Application Publication
(10) Pub. No.: US 2004/0041803 A1
(43) Pub. Date: Mar. 4, 2004

(54) Energy-saving carry-on chronometric device having cholesteric color liquid crystal display

(76) Inventor: Yuan Sung Weng, Taipei (TW)

Correspondence Address: BUCKNAM AND ARCHER, 1077 Northern Boulevard, Roslyn, NY, 11576-1696, US

(21) Appl. No.: 10/462,938

(22) Filed: Jun. 17, 2003

(30) Foreign Application Priority Data
Sep. 3, 2002 (TW) 091213803

(51) Int. Cl. G09G 5/00

(52) U.S. Cl. 345/211

(57) ABSTRACT

The invention provides an energy-saving carry-on chronometric device having a cholesteric color liquid crystal display, having a power supply unit for supplying a working voltage; a chronometric unit for providing time data; a storage unit for storing a plurality of image data; a cholesteric color liquid crystal display unit for displaying time data and image data; a display control unit for controlling a displaying behavior of the cholesteric color liquid crystal display unit; a control switch unit connected between the power supply unit and the cholesteric color liquid crystal display unit, wherein when the chronometric unit is set in a time mode, the control switch unit may switch on and then off the working voltage of the cholesteric color liquid crystal display, which is supplied by the power supply unit, with a preset period of time so as to continuously display the time data which is the same as that of when switching off the working voltage.

### BACKGROUND OF THE INVENTION

The invention generally relates to an energy-saving carry-on chronometric device having a cholesteric color liquid crystal display and, more specifically to a carry-on chronometric device having a cholesteric color liquid crystal display unit capable of displaying the image which was just displayed before a control switch unit switched off a power supplied to the cholesteric color liquid crystal display unit in a preset period of time so as to display a time data which is the same as that of when switching off the power, in order to reduce energy consumption.

### DESCRIPTION OF THE PRIOR ART

In the current market, in order to fulfill a need for modern customers for convenient use at any time and any place, the manufactures tend to miniaturize electronic products for easy carry and practical use. To achieve a portable convenience for products such as personal digital assistant (PDA), digital camera, and mobile phone, it is not only to make these products light, thin, short, and small for easy carry, but also to make these products energy-saving for allowing a long time use to increase the efficiency of use without frequently replacing or recharging battery. An ordinary carry-on chronometric device has adapted a monochromatic gray-scaled twisted nematic liquid crystal display (TN-LCD) or a thin film transistor liquid crystal display (TFT- LCD) to be its display. Although the above display has feature of small volume, the display needs to be equipped with a refresh circuit to perform a continuous scan on the image for the variation of image as well as needs to be supplied with power to perform continuous image display. Therefore, such a display may consumes more energy.

Particularly, when it is desired to adapt a color liquid crystal display for carry-on chronometric device to display versatile color functions, the color liquid crystal display may be useless due to its large energy consumption. Accordingly, the applicant disclosed a carry-on device having cholesteric liquid crystal display which was filed on Sep. 17, 2002 with application No. U.S. Ser. No. 10/244,744 and described a carry-on device which utilizes a cholesteric liquid crystal display capable of displaying the image which was just displayed before a power control switch was turned off when no power is supplied thereto while consuming less power to maintain a long time displaying. The application will be entirely incorporated herein by reference.

However, when it is desired to combine a cholesteric color liquid crystal display into a chronometric device to display a picture image or time data, the power should be continuously supplied to the cholesteric color liquid crystal display for displaying a real time data. Therefore, there still exists the problem of energy consumption. Thus, it is necessary for development of an energy-saving carry-on chronometric device which can be energy-saving not only for displaying the image, but also for displaying the time.

### SUMMARY OF THE INVENTION

Therefore, for solving the above problems, an object of the invention is to provide an energy-saving carry-on chronometric device having a cholesteric color liquid crystal display having a cholesteric color liquid crystal display, and namely to provide a carry-on chronometric device having a cholesteric color liquid crystal display unit capable of displaying the image which was just displayed before a control switch unit switched off a power supplied to the cholesteric color liquid crystal display unit in a preset period of time so as to display a time data which is the same as that of when switching off the power in order to reduce energy consumption.

For achieving the above object, in accordance with an aspect of the invention, an energy-saving carry-on chronometric device having a cholesteric color liquid crystal display is provided, comprising a power supply unit, including a voltage source, for supplying a working voltage; a chronometric unit, for providing time data; a storage unit, for storing a plurality of image data; a cholesteric color liquid crystal display unit, having two glass substrates and a cholesteric liquid crystal layer which is filled and sealed between the two glass substrates, for displaying colorfully the time data and the image data in a time mode and an image mode, respectively; a display control unit, electrically connected to the power supply unit, the storage unit and the cholesteric color liquid crystal display unit, for controlling image display of the cholesteric color liquid crystal display unit according to different image data stored in the storage unit; and a control switch unit, connected between the power supply unit and the cholesteric color liquid display unit, for switching on and off the working voltage supplied by the power supply unit to the cholesteric color liquid crystal display unit, wherein when the chronometric unit is set in a time mode, the control switch unit may switch on and then off the working voltage of the cholesteric color liquid crystal display unit, which is supplied by the power supply unit, with a preset period of time so as to continuously display the time data which is the same as that of when switching off the working voltage of the cholesteric color liquid crystal display unit based on a feature of the cholesteric color liquid crystal display in order to save energy consumption of the chronometric device.

The chronometric device according to the above aspect, the preset period of time is one minute and the working voltage of the cholesteric color liquid crystal display unit is switched on and then off at a first one second of each of the one minute.

The chronometric device according to the above aspect, further comprises a transmission interface unit connected to the storage unit for transmitting image with other devices via the connection of the transmission interface unit, wherein the other devices include personal computer, personal digital assistant (PDA) and the like.

### BRIEF DESCRIPTION OF DRAWINGS

Other features and advantages of the present invention will become more apparent from the detailed description in conjunction with the following drawings:

FIG. 1 is a block diagram showing a first preferred embodiment of the invention;

FIG. 2 is a flow chart showing operation procedure of the first preferred embodiment;

FIG. 3 is a schematic diagram showing a product of the first preferred embodiment; and

FIG. 4 is a block diagram showing a second preferred embodiment of the invention.

### DETAILED DESCRIPTION OF THE INVENTION

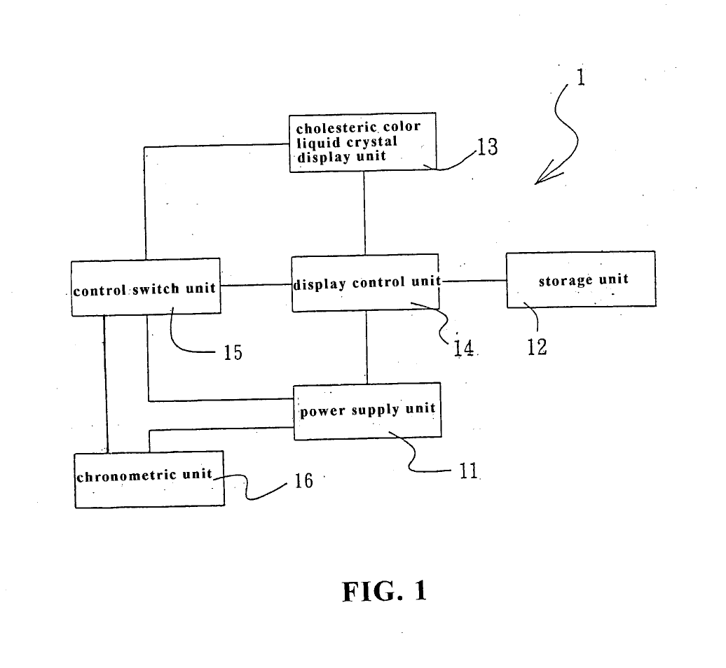

Referring to FIG. 1, FIG. 1 shows a first preferred embodiment of an energy-saving carry-on chronometric device having cholesteric color liquid crystal display of the invention. The energy-saving carry-on chronometric device 1 having a cholesteric color liquid crystal display comprises a power supply unit 11; a storage unit 12; a cholesteric color liquid crystal display unit 13; a display control unit 14, electrically connected to the power supply unit 13, the storage unit 12 and the cholesteric color liquid crystal display unit 13; a control switch unit 15, connected between the power supply unit 11 and the cholesteric color liquid crystal display unit 13; and a chronometric unit 16, connected to the power supply unit 11 and the control switch unit 15.

The power supply unit 11 is a battery of DC power supply source for outputting a working voltage, and the storage unit 12 is a built-in memory for storing a plurality of image data therein.

The cholesteric color liquid crystal display unit 13 has two glass substrates, and a cholesteric liquid crystal layer imperviously filled between said glass substrates. The cholesteric liquid crystal layer is formed of a stack of several nematic liquid crystal layers. Molecules of each cholesteric liquid crystal layer are arranged in a spiral plane around an asymmetric carbon center. Such planes are parallel to each other, while long axes of molecules on different planes may orient in different direction in order to form an angle therebetween. The distance between two planes with the long axes of molecules oriented in the same direction is defined as a “pitch”. Using electric fields of different strengths to change the length of the pitch, it is possibly to selectively reflect light of different wavelengths and display various colors. Therefore, no transmission of backlight source but the reflection of ambient light or artificial external light source is needed to perform the image display of time data or image data on a cholesteric color liquid crystal display unit 13 with a compact size in time mode or image mode. Since the cholesteric color liquid crystal display unit 13 is manufactured by an existing technology, no more details is provided in the attached drawings but simply illustrated by a block in the block diagram.

The display control unit 14 is connected to the power supply unit 11, the storage unit 12 and the cholesteric color liquid crystal display unit 13; and it allows the cholesteric liquid crystal layer to reflect light of different wavelengths by changing the strength of electric field between the two glass substrates of the cholesteric liquid crystal display unit 13 so as to perform the time data or image data in accordance with the time mode or image mode.

Further, the control switch unit 15 is provided between the power supply unit 11 and the cholesteric color liquid crystal display unit 13, such that the user may operate the control switch unit 15 to exhibit an on or off state. When the control switch unit 15 is in on state the display control unit 14 and the power supply unit 11 can be turned on and the cholesteric color liquid crystal display unit 13 may receive the working voltage from the power supply unit 11, and the display control unit 14 may control the cholesteric color liquid crystal display unit 13 to display the time data of the chronometric unit 16 or the image data stored in the storage unit 12, respectively. That is to say, the single cholesteric color liquid crystal display unit 13 can simply serve to display both of the time data of the carry-on chronometric device 1 and the image data. Normally, an exemplary carry-on chronometric device always employs a single LCD display (for example, STN or TFT) for display of both of time data and image data. When serving as the carryon chronometric device, traditionally, it nearly display the time data in 24 hours every day. However, if it also has the image display function in the single display unit such as STN or TFT LCD, the 24 hours—continuous display of the time data may consume a considerable energy of the battery. Further the error within around one minute can always be acceptable when the user checks on the time data. Therefore, the carry-on chronometric device 1 of the present invention is designed to control the display unit 13 so that the display unit 13 can be supplied with power by the control of the display control unit 14 and activated to switch on for the display of the current time data in a predetermined period of time, such as the first second of every minute, and then immediately be deactivated to switch off. By means of the persistence property of the cholesteric liquid crystal, the cholesteric color liquid crystal display unit 13 will continuously display the last image without any power being provided to the display unit 13. Upon the first second of the next one minute, the display unit 13 will be activated and then deactivated again so as to display the time data of the next one minute. Thus, the power consumption for the device 1 of the present invention will be nearly one-sixtieth of that for the conventional carry-on chronometric device having image display function.

The chronometric unit 16 may receive a working voltage outputted from the power supply unit 11 to perform the time mode, which is the ordinary chronometric mode of a digital watch, the detailed description will be thus omitted here.

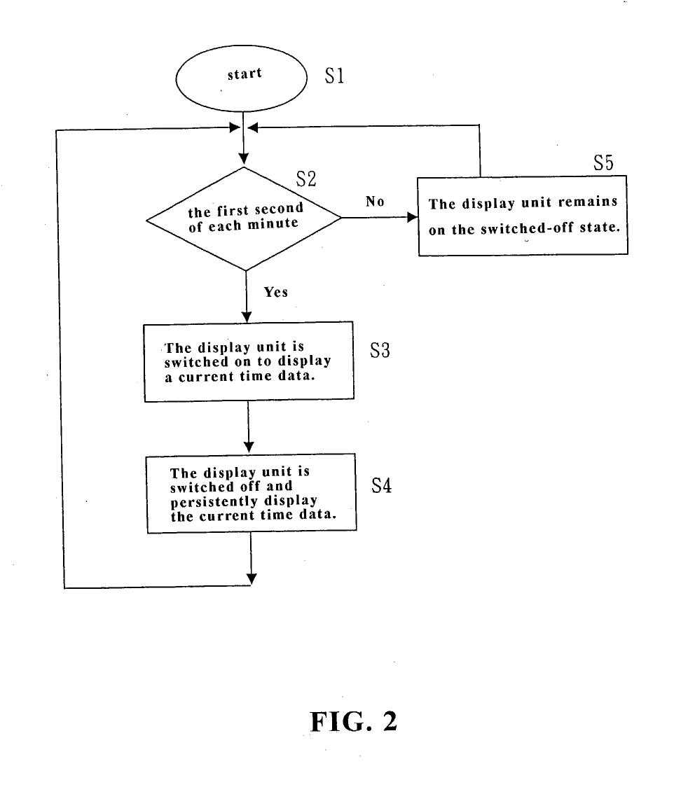

Referring to FIG. 2, FIG. 2 is a flow chart showing operation procedure of the first preferred embodiment. Initially, when the carry-on chronometric device 1 is set in the time mode (step S1), the control switch unit 15 checks whether the time is the first second of the one minute or not (step S2). If the time is the first second of the one minute, then the display unit 13 is switched on to display a current time in place of the display of the previous time (step S3). After the time is updated, the display unit 13 is switched off and displays persistently the current time (step S4). Afterwards, the procedure returns to the step S2 to check whether the time is the first second of the next minute. If not, the display unit 13 continuously remains in the switched-off state (step S5), until the time is the first second of the next minute.

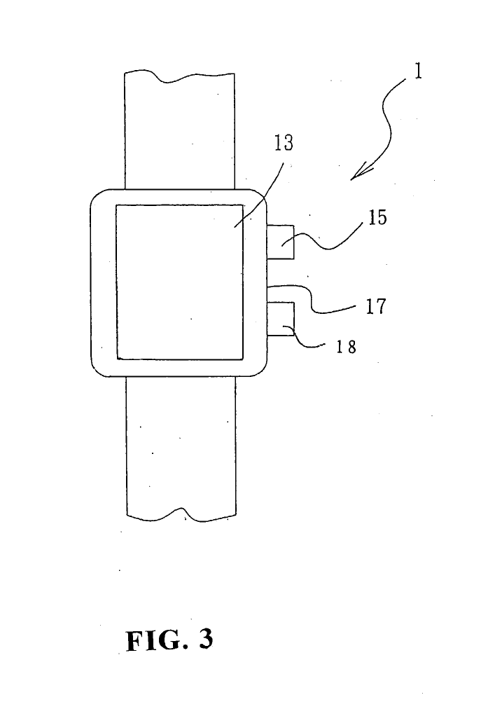

In FIG. 3, further description is made to a product manufactured in accordance with the first preferred embodiment. However, the present invention is not limited to such product but can be a carry-on chronometric device such as a digital watch worn on the user's hand. The energy-saving chronometric device 1 has a cholesteric color liquid crystal display unit 13 mounted thereon and a control switch unit 15. Elements such as power supply unit 11, storage unit 12, display control unit 14 and part of circuit in chronometric unit 16 as shown in FIG. 1 are provided inside the panel 17 but not explicitly shown in FIG. 3. The user may push the selection key 18 to have the cholesteric color liquid crystal display unit 13 worked in time mode or image mode so as to display the time data or image data. When the user pushes the control switch unit 15, the cholesteric color liquid crystal display unit 13 is allowed to perform a long time persistent display of the image without any power being supplied to the display unit 13. The display unit 13 will automatically return to the time mode from the image mode in a predetermined period of time if the control switch unit 15 is not pushed again. According to the aspect of the present invention, the control switch unit 15 may switch on and then off the working voltage of the cholesteric color liquid crystal display, which is supplied by the power supply unit 11, with a preset period of time so as to continuously display the time data which is the same as that of when switching off the working voltage.

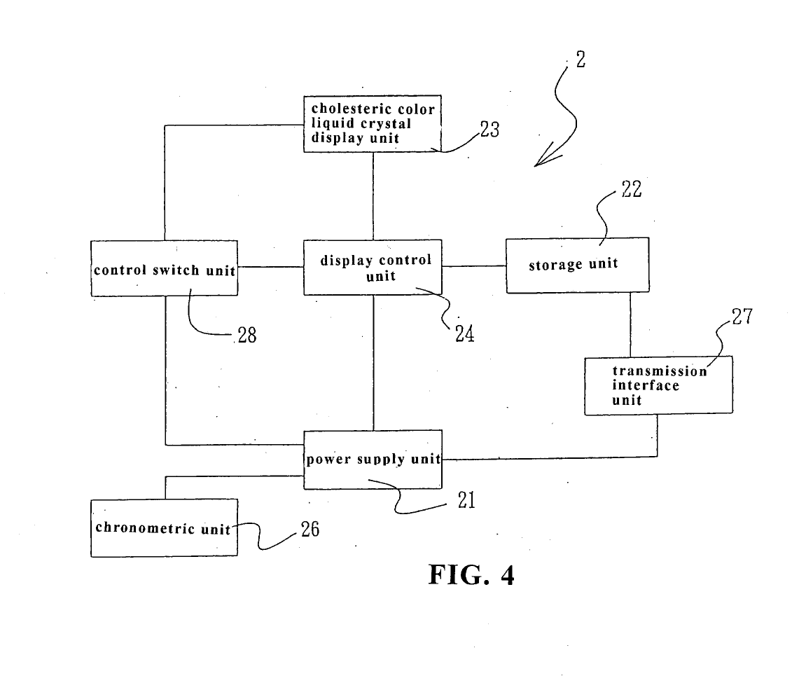

Referring to FIG. 4, FIG. 4 shows a second preferred embodiment of the invention. A carry-on chronometric device 2 provided similar to the first embodiment of the present invention comprises a power supply unit 21, a storage unit 22, a cholesteric color liquid crystal display unit 23, a display control unit 24, a chronometric unit 26 and a control switch unit 28. The only difference is that the carry-on chronometric device 2 is provided with a transmission interface unit 27, which is connected to the power supply unit 21 and the storage unit 22. The external image data can be decoded or converted via the transmission interface unit 27 so as to be stored in the storage unit 22. The stored image can also be transmitted via an infrared ray transmission with other devices such as a computer or a personal digital assistant (PDA) in order to allow the data transmission for the carry-on chronometric device 2 of the present invention. The data conversion/transmission technology used in the transmission interface unit 27 is well known in the prior art, therefore no detailed description will be provided here. Also, the cholesteric color liquid crystal display unit 23 has similar energy-saving function as that of the first embodiment, that is, the cholesteric color liquid crystal display unit 23 may perform a long time image display under the condition of no electric power supplied thereto.

Summing up the above description, the present invention provides a compact sized, energy-saving carry-on device having a cholesteric color liquid crystal display, in which making use the feature of the cholesteric color liquid crystal display may continuously display on image data after turning off the control switch unit. Thus, it meets the necessary requirement for a carry-on device. Also, the transmission interface unit is used to perform data exchange with other devices so that it is possible to increase the usefulness and convenience, and to precisely achieve the object of the present invention.

Above described are preferred embodiments of the present invention and not intended to limit the present invention, simple equivalent change and modification without departing from the appended claims must be considered as falling within the scope of the invention.

### List of Reference Numerals

1, 2 carry-on chronometric device 11, 12 power supply unit 12, 22 storage unit

13, 23 cholesteric color liquid crystal display unit 14, 24 display control unit 16, 26 chronometric unit

15, 28 control switch unit 17 panel

18 selection button

27 transmission interface unit

What is claimed is:

1. An energy-saving carry-on chronometric device having a cholesteric color liquid crystal display, comprising:
a power supply unit, including a voltage source, for supplying a working voltage;
a chronometric unit, for providing time data;
a storage unit, for storing a plurality of image data;
a cholesteric color liquid crystal display unit, having two glass substrates and a cholesteric liquid crystal layer filled between the two glass substrates, for displaying the time data and the image data;
a display control unit, electrically connected to the power supply unit, the storage unit and the cholesteric color liquid crystal display unit, for controlling image display of the cholesteric color liquid crystal display unit according to different image data stored in the storage unit; and
a control switch unit, connected between the power supply unit and the cholesteric color liquid crystal display unit, for switching on and off the working voltage supplied by the power supply unit to the cholesteric color liquid crystal display unit, wherein when the chronometric unit is set in a time mode, the control switch unit may switch on and then off the working voltage of the cholesteric color liquid crystal display unit, which is supplied by the power supply unit, with a preset period of time, so as to continuously display the time data which is the same as that of when switching off the working voltage of the cholesteric color liquid crystal display unit based on a feature of the cholesteric color liquid crystal display in order to save energy consumption of the chronometric device.

2. The chronometric device according to claim 1, wherein the preset period of time is one minute, and the working voltage of the cholesteric color liquid crystal display unit is switched on and then off at a first second of each minute.

3. The chronometric device according to claim 1, further comprising a transmission interface unit, connected to said storage unit, for transmitting image with other devices via the connection of said transmission interface unit, wherein said other devices include personal computer, personal digital assistant (PDA) and the like.
